(19) United States
(12) Patent Application Publication
(10) Pub. No.: US 2006/0094476 A1
(43) Pub. Date: May 4, 2006

(54) Fast synchronization functionality for wireless access points

(76) Inventor: Wey-Yi Guy, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/979,548

(22) Filed: Nov. 1, 2004

(51) Int. Cl. H04Q 7/20

(52) U.S. Cl. 455/574; 455/572

(57) ABSTRACT

A method for synchronizing a mobile station includes exiting a low power state to provide a wireless network and obtaining an identity and a last known power state of the mobile station from a station list. The mobile station is polled based on the last known power state and noted as synchronized if the polling is acknowledged. If the polling is not acknowledged, the mobile station is polled a second time based on an alternate power state and noted as synchronized if the second polling is acknowledged. If the second polling is not acknowledged, the mobile station is disassociated from the wireless network.

### BACKGROUND

In a conventional wireless infrastructure network, mobile stations (e.g., a laptop computer with a wireless connection) are associated with a wireless access point (AP) within a basic service set. There may be multiple mobile stations within range of an AP, and the AP generally remains in an active power state while servicing the one or more mobile stations.

Mobile stations may use different power states to conserve power while still providing a high quality user experience. For instance, a mobile station may be in an active power state when the mobile station is in use and generating traffic on a wireless network. Alternately, the mobile station may implement a power saving protocol, such as power save polling (PSP), to enter a standby power state that conserves power when the mobile station is inactive or not generating traffic on a wireless network.

Unlike mobile stations, APs must remain in an active power state at all times. Conventional APs do not use PSP or other power saving protocols to enter a power standby state. This results in an unnecessary waste of power when there is no traffic on a wireless network. For instance, if an AP is servicing mobile stations that have (1) entered a standby power state, or (2) are not generating traffic on the wireless network, then the AP does not have to remain in an active state. If power saving functionality is implemented in an AP, there will be concerns about performance losses and an overall poor user experience if the chosen power saving protocol does not enable fast synchronization with associated mobile stations when the AP wakes up from a standby power state.

### BRIEF DESCRIPTION OF THE DRAWINGS

FIG. 1 illustrates one implementation of a wireless network infrastructure.

FIG. 2A is a method for an AP to enter a power saving state in accordance with an implementation of the invention.

FIG. 2B is a station list in accordance with an implementation of the invention.

FIG. 3 is a method for fast synchronization according to an implementation of the invention.

FIG. 4 illustrates polling interactions between an access point and four mobile stations conducted in accordance with an implementation of the invention.

### DETAILED DESCRIPTION

The following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known circuits, structures and techniques have not been shown in detail in order not to obscure an understanding of this description.

References to “one implementation”, “an implementation”, “example implementation”, “various implementations”, etc., indicate that the implementation(s) of the invention so described may include a particular feature, structure, or characteristic, but not every implementation necessarily includes the particular feature, structure, or characteristic. Further, the different implementations described may have some, all, or none of the features described for other implementations.

In the following description and claims, the terms “coupled” and “connected,” along with their derivatives, may be used. It should be understood that these terms are not intended as synonyms for each other. Rather, in particular implementations, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some implementations they might not.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner. Various operations will be described as multiple discrete operations, in turn, in a manner that is most helpful in understanding the present invention, however, the order of description should not be construed to imply that these operations are necessarily order dependent. In particular, these operations need not be performed in the order of presentation.

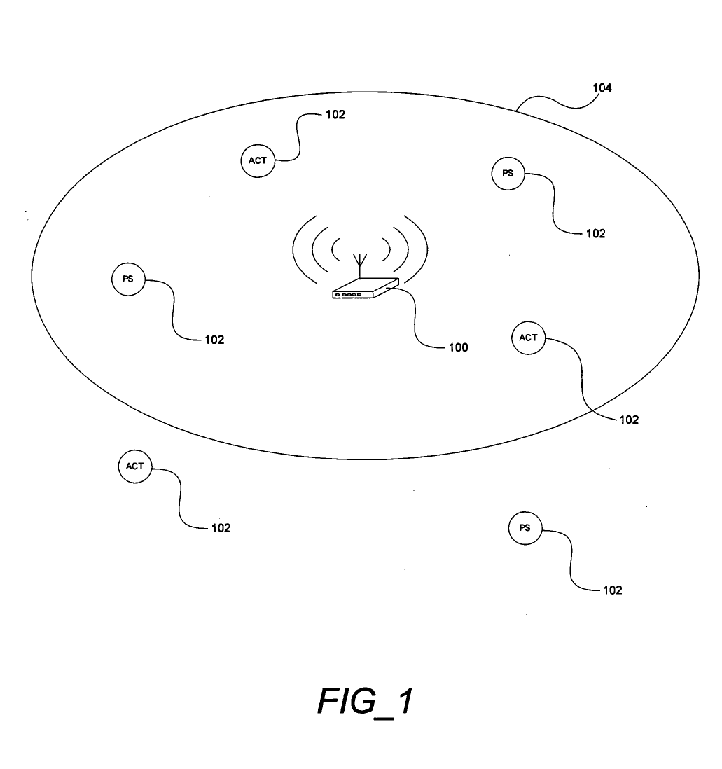

FIG. 1 illustrates one implementation of a wireless network that includes a wireless access point (AP) 100 and multiple mobile stations 102. The mobile stations 102 may include, but are not limited to, laptop computers, notebook computers, personal digital assistants (PDAs), pagers, and mobile telephones. The AP 100 establishes a wireless local area network (WLAN) 104. The WLAN 104 may be a basic service set and it may form a portion of an expanded service set. Mobile stations 102 may connect to the AP 100 to join the WLAN 104. Mobile stations 102 out of range of the AP 100 cannot join the WLAN 104.

The mobile stations 102 may be in any one of several power states. Some mobile stations 102 may be in an active power state, therefore these mobile stations 104 may be actively generating data traffic on the WLAN 104. In FIG. 1, the mobile stations 102 in an active power state are labeled as “ACT”. Alternately, some mobile stations 102 may be in a power saving state, therefore these mobile stations 102 will be generating minimal or no data traffic on the WLAN 104. In FIG. 1, the mobile stations 102 in a power saving state are labeled as “PS”. In some implementations, the mobile stations 102 may use power save polling (PSP) as part of their power saving state. In some implementations, alternate power saving protocols may be used by the mobile stations 102.

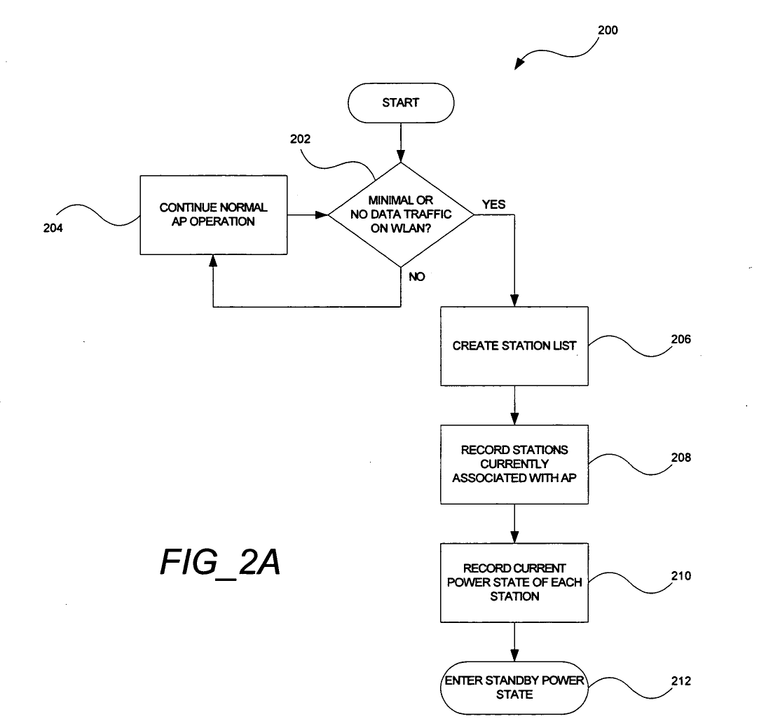

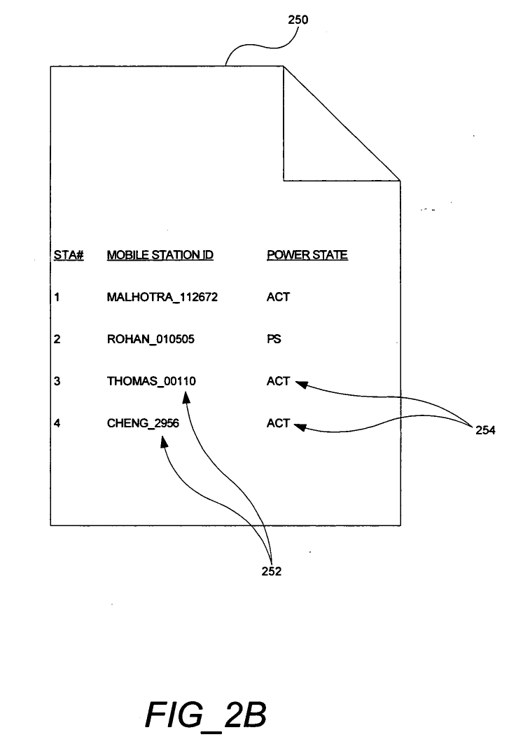

FIG. 2A is a method 200, according to an implementation of the invention, that may be used by the AP 100 to enter a power saving state if there is minimal or no data traffic on the WLAN 104. The AP 100 may continuously monitor traffic on the WLAN 104 to determine if the flow of data has reached a threshold minimum level or has stopped (202). While there is an active flow of data on the WLAN 104, the AP 100 continues with its normal operation (204). If, however, the data traffic on the WLAN 104 has dropped to a threshold minimum level or has ceased completely, the AP 100 may take steps to enter a power saving state to conserve power. In an implementation of the invention, the AP 100 begins this process by defining a station list (206). The station list may be a data file, such as an Extensible Markup Language (XML) file or a text file (.txt), or the station list may be stored data residing in a memory of the AP 100, such as a random access memory or a flash memory. The AP 100 determines which mobile stations 102 are currently being serviced by the AP 100 and records their identities to the station list (208). In addition, the AP 100 may also record the current power state, active or power saving, of each mobile station 102 that is added to the station list (210).

When all of the mobile stations 102 that are associated with the AP 100 have been recorded on the station list with their respective power states, the AP 100 may enter a power saving state (212). In some implementations, the power saving state may be a sleep mode, a stand-by mode, a hibernation mode, or any other power saving protocol that is appropriate for the AP 100.

FIG. 2B is an exemplary station list 250 that may be generated by the AP 100. As shown, the station list 250 may include a unique identity 252 of each mobile station 102 that is associated with the AP 100 at the time the AP 100 enters a power saving state. The unique identity 252 of each mobile station 102 may have been previously created by a user of that particular mobile station 102. The unique identity 252 is generally received from the mobile station 102 when the mobile station 102 first connects to the AP 100. The station list 250 also includes the power state 254 of each mobile station 102 at the time the station list 250 was generated. In FIG. 2B, the possible power states include an active power state (ACT) and a power saving state (PS).

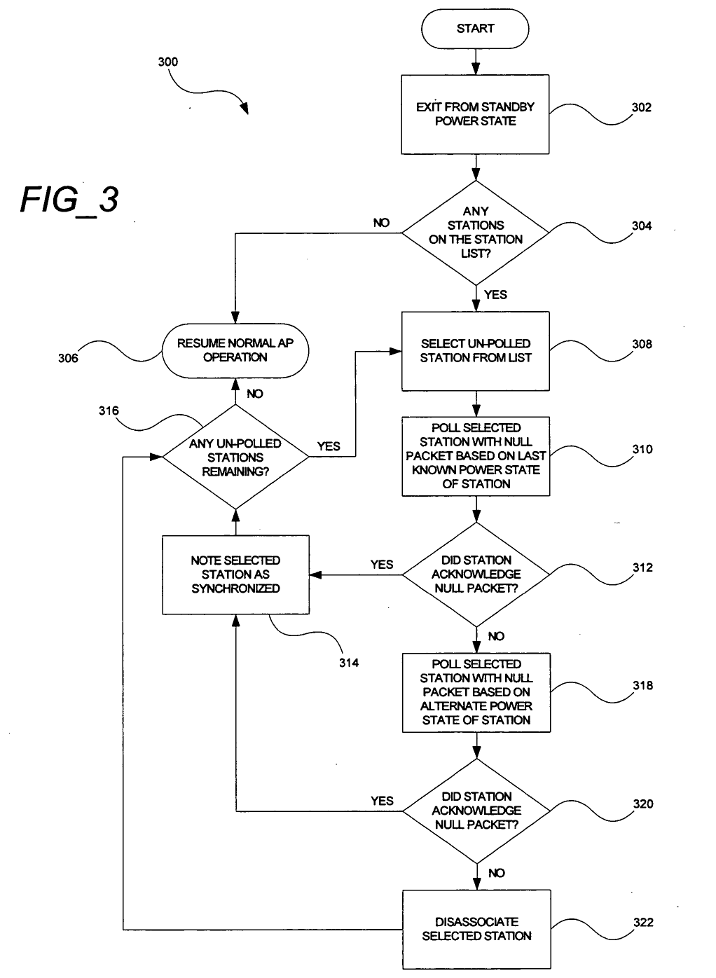

FIG. 3 is a method 300, in accordance with an implementation of the invention, for the AP 100 to synchronize with one or more mobile stations 102. The method 300 may be carried out when the AP 100 wakes up from or exits a power saving state (302). The AP 100 determines if one or more mobile stations 102 were recorded to the station list 250 when the AP 100 originally went into the power saving state (304). If the station list 250 contains no unique identities 252, the AP 100 may resume normal operation (306).

If, however, the station list 250 includes one or more recorded unique identities 252, the AP 100 may attempt to synchronize the mobile stations 102 associated with the recorded unique identities 252. To perform the synchronization, the AP 100 begins by selecting one mobile station 102 that has not been polled (308). Initially, all of the mobile stations 102 recorded on the station list 250 will not have been polled.

The AP 100 may poll the selected mobile station 102 with a null packet based on the last known power state of that mobile station 102 (310). In an implementation, the last known power state of the selected mobile station 102 may be found on the station list 250. Generally, the power state 254 recorded for the selected mobile station 102 when the AP 100 entered the power saving state is the last known power state of that mobile station 102. Accordingly, if the station list 250 discloses that the power state of the selected mobile station 102 is an active power state, the AP 100 may send a null packet to the selected mobile station 102 based on an active power state. Alternately, if the station list 250 discloses that the power state of the selected mobile station 102 is a power saving state, the AP 100 may send a null packet to the selected mobile station 102 based on a power saving state.

The AP 100 may wait for an acknowledgement from the selected mobile station 102 that it has received the null packet (312). In some implementations, the AP 100 may wait a predetermined amount of time for the selected mobile station 102 to acknowledge the null packet. If the mobile station 102 acknowledges the null packet, the AP 100 notes that the selected mobile station is synchronized (314). The AP 100 may then check the station list 250 to determine whether any mobile stations 102 remain that have not been polled by the AP 100 (316). If un-polled mobile stations 102 remain, the AP 100 may select another mobile station 102 to poll (308). If all of the mobile stations 102 recorded on the station list 250 have been polled, the AP 100 may resume normal operation (306).

If the selected mobile station 102 does not acknowledge the null packet from the AP 100, the AP 100 may poll the selected mobile station 102 with a second null packet that is based on an alternate power state (318). For instance, if the first null packet was based on an active power state, the second null packet may be based on a power saving state. Similarly, if the first null packet was based on a power saving state, the second null packet may be based on an active power state.

The AP 100 may wait for an acknowledgement from the selected mobile station 102 that it has received the second null packet (320). In some implementations, the AP 100 may wait a predetermined amount of time for the selected mobile station 102 to acknowledge the second null packet. If the mobile station 102 acknowledges the second null packet, the AP 100 notes that the selected mobile station is synchronized (314). As described previously, the AP 100 may then check the station list 250 to determine whether any un-polled mobile stations 102 remain (316), and if so, the AP 100 may select another mobile station 102 to poll (308). Alternately, if all of the mobile stations 102 recorded on the station list 250 have been polled, the AP 100 may resume normal operation (306).

If the selected mobile station 102 does not acknowledge the second null packet, the AP 100 may determine that the mobile station 102 is unavailable and may disassociate the selected mobile station 102 from the WLAN (322). The mobile station 102 may be unavailable for many reasons. For instance, the mobile station 102 may have moved to a location that is out of range of the AP 100. Alternately, the mobile station 102 may have turned off its wireless functionality or it may have shut down.

After the AP 100 disassociates the selected mobile station 102, the AP 100 may check the station list 250 to determine whether any un-polled mobile stations 102 remain (316), and if so, the AP 100 may select another mobile station 102 to poll (308). Alternately, if all of the mobile stations 102 recorded on the station list 250 have been polled, the AP 100 may resume normal operation (306).

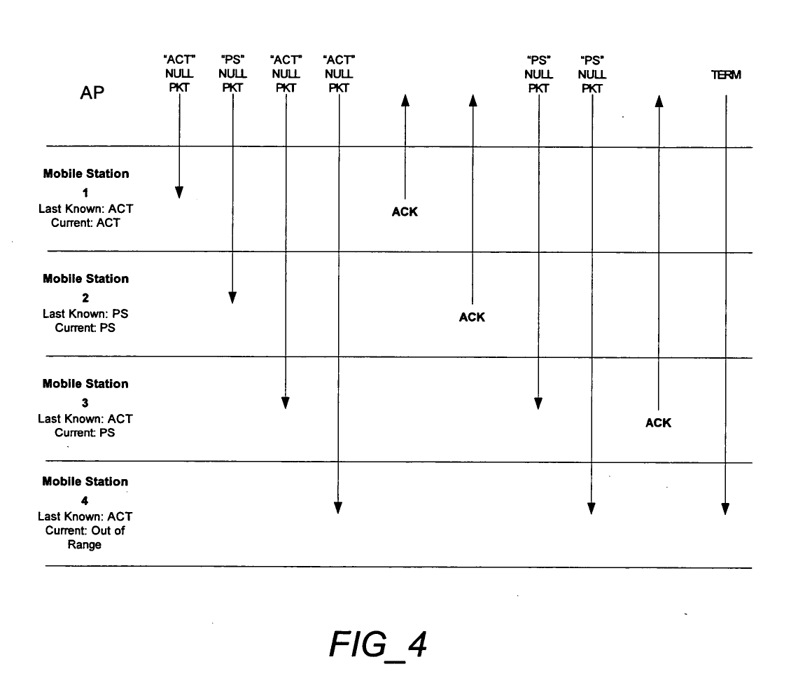

FIG. 4 illustrates an example of polling transactions that may occur between the AP 100 and four mobile stations 102 according to an implementation of the invention. In the example of FIG. 4, mobile station #1 was in an active power state when the AP 100 went into standby and is in an active power state when the AP 100 wakes up. Mobile station #2 was in a power saving state when the AP 100 went into standby and is in a power saving state when the AP 100 wakes up. Mobile station #3 was in an active power state when the AP 100 went into standby and is in a power saving state when the AP 100 wakes up. And mobile station #4 was in an active power state when the AP 100 went into standby and is currently out of range of the AP 100.

As shown in FIG. 4, the AP 100 polls each of the four mobile stations 102 based on the last known power state of each mobile station. The last known power state may be found on the station list 250. For mobile stations #1, #3, and #4, the last known power state is active, and the AP 100 polls each of these mobile stations with a null packet based on an active power state (ACT). For mobile station #2, the last known power state is power saving, and the AP 100 polls mobile station #2 with a null packet based on a power saving state (PS).

In FIG. 4, mobile station #1 receives the null packet based on an active power state and transmits an acknowledgement (ACK) back to the AP 100. Similarly, mobile station #2 receives the null packet based on a power saving state and transmits an acknowledgement (ACK) back to the AP 100. The AP 100 may note mobile stations #1 and #2 as synchronized. Mobile station #3, which received a null packet based on an active power state, cannot acknowledge the null packet because it is now in a power saving state. Mobile station #4, which has moved out of range of the AP 100, does not receive the null packet and therefore cannot respond.

The AP 100 may wait a predetermined amount of time for an acknowledgement from mobile stations #3 and #4. When no acknowledgement is received during the predetermined time, the AP 100 may transmit a second null packet to mobile stations #3 and #4 based on an alternate power state. Since the first null packets to both mobile stations #3 and #4 were based on an active power state, the second null packets to both may be based on a power saving state. In FIG. 4, the AP 100 transmits null packets based on a power saving state to mobile stations #3 and #4. Mobile station #3, because it is in a power saving state, may finally acknowledge the null packet, and the AP 100 may note mobile station #3 as synchronized. Mobile station #4, which cannot receive the second null packet since it is out of range, again does not respond. The AP 100 may then disassociate mobile station #4 from the WLAN.

Implementations of the invention enable the AP 100 to screen out all mobile stations 102 that have moved out of range or have changed power state during the time when the AP 100 was in a power standby state. Implementations of the invention allow the AP 100 to go into power standby state when there is no active traffic being detected, and allow the AP 100 to wake up as soon as any traffic from mobile stations 102 is detected. The AP 100 may then perform the methods of the invention to synchronize mobile stations 102 with improved performance loss.

The invention may be implemented in one or a combination of hardware, firmware, and software. The invention may also be implemented as instructions stored on a machine-readable medium, which may be read and executed by a processing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM), such as dynamic random access memory (DRAM); magnetic disk storage media; optical storage media; flash memory devices; electrical, optical, acoustical or other form of propagated signals (e.g., carrier waves, infrared signals, digital signals, the interfaces that transmit and/or receive those signals, etc.), and others.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A method comprising:
providing a wireless network;
monitoring a level of data traffic on the wireless network generated by a mobile station, wherein the mobile station has a unique identity; and
if the level of data traffic falls to or below a predetermined threshold:
recording the unique identity on a station list, and
entering a low power state.

2. The method of claim 1, wherein if the level of data traffic falls below a predetermined threshold, the method further comprises recording a last known power state of the mobile station on the station list.

3. The method of claim 2, wherein the last known power state is an active power state or a power saving state.

4. The method of claim 1, wherein the station list is a data file.

5. The method of claim 1, wherein the predetermined threshold is 0 bits per second.

6. The method of claim 1, wherein the low power state is a hibernation state, a sleep state, a power-saving state, or a stand-by state.

7. A method comprising:
exiting a low power state to provide a wireless network;
obtaining an identity of a mobile station and a last known power state of the mobile station from a station list;
polling the mobile station based on the last known power state; and
noting the mobile station as synchronized if the polling is acknowledged, else
polling the mobile station a second time based on an alternate power state; and
noting the mobile station as synchronized if the second polling is acknowledged, else disassociating the mobile station from the wireless network.

8. The method of claim 7, wherein the low power state is a hibernation state, a sleep state, a power-saving state, or a stand-by state.

9. The method of claim 7, wherein the station list is a data file.

10. The method of claim 7, wherein the last known power state of the mobile station is an active power state or a power saving state.

11. The method of claim 10, wherein if the last known power state of the mobile station comprises the active power state, then polling the mobile station based on the last known power state comprises transmitting a null packet to the mobile station based on the active power state.

12. The method of claim 10, wherein if the last known power state of the mobile station comprises the power saving state, then polling the mobile station based on the last known power state comprises transmitting a null packet to the mobile station based on the power saving state.

13. The method of claim 10, wherein if the last known power state of the mobile station comprises the active power state, then polling the mobile station a second time based on an alternate power state comprises transmitting a null packet to the mobile station based on the power saving state.

14. The method of claim 10, wherein if the last known power state of the mobile station comprises the power saving state, then polling the mobile station a second time based on an alternate power state comprises transmitting a null packet to the mobile station based on the active power state.

15. The method of claim 7, wherein the polling is acknowledged if an acknowledgement is received from the mobile station based on the polling.

16. The method of claim 13, wherein the second polling is acknowledged if an acknowledgement is received from the mobile station based on the second polling.

17. The method of claim 7, further comprising waiting a predetermined amount of time for an acknowledgement from the mobile station after the polling of the mobile station.

18. The method of claim 7, further comprising waiting a predetermined amount of time for an acknowledgement from the mobile station after the second polling of the mobile station.

19. An article comprising a machine-readable medium that provides instructions, which when executed by a processing platform, cause the processing platform to perform operations comprising:
exiting a low power state to provide a wireless network;
obtaining an identity of a mobile station and a last known power state of the mobile station from a station list;
polling the mobile station based on the last known power state; and
noting the mobile station as synchronized if the polling is acknowledged, else
polling the mobile station a second time based on an alternate power state; and
noting the mobile station as synchronized if the second polling is acknowledged, else disassociating the mobile station from the wireless network.

20. The article of claim 19, wherein the station list is a data file.

21. The article of claim 19, wherein the last known power state of the mobile station is an active power state or a power saving state.

22. The article of claim 21, wherein if the last known power state of the mobile station is the active power state, then the operation of polling the mobile station based on the last known power state comprises the operation of transmitting a null packet to the mobile station based on the active power state.

23. The article of claim 21, wherein if the last known power state of the mobile station is the power saving state, then the operation of polling the mobile station based on the last known power state comprises the operation of transmitting a null packet to the mobile station based on the power saving state.

24. The article of claim 21, wherein if the last known power state of the mobile station is the active power state, then the operation of polling the mobile station a second time based on an alternate power state comprises the operation of transmitting a null packet to the mobile station based on the power saving state.

25. The article of claim 21, wherein if the last known power state of the mobile station is the power saving state, then the operation of polling the mobile station a second time based on an alternate power state comprises the operation of transmitting a null packet to the mobile station based on the active power state.

26. A wireless communication apparatus comprising:
a memory; and
a software application residing in the memory that provides instructions, which when executed by a processor, cause the processor to perform operations comprising:
exiting a low power state to provide a wireless network;
obtaining an identity of a mobile station and a last known power state of the mobile station from a station list;
polling the mobile station based on the last known power state; and
noting the mobile station as synchronized if the polling is acknowledged, else
polling the mobile station a second time based on an alternate power state; and
noting the mobile station as synchronized if the second polling is acknowledged, else disassociating the mobile station from the wireless network.

27. The apparatus of claim 26, wherein if the last known power state of the mobile station comprises an active power state, then the operation of polling the mobile station based on the last known power state comprises the operation of transmitting a null packet to the mobile station based on the active power state.

28. The apparatus of claim 26, wherein if the last known power state of the mobile station comprises a power saving state, then the operation of polling the mobile station based on the last known power state comprises the operation of transmitting a null packet to the mobile station based on the power saving state.

29. The apparatus of claim 26, wherein if the last known power state of the mobile station comprises an active power state, then the operation of polling the mobile station a second time based on an alternate power state comprises the operation of transmitting a null packet to the mobile station based on a power saving state.

30. The apparatus of claim 26, wherein if the last known power state of the mobile station comprises a power saving state, then the operation of polling the mobile station a second time based on an alternate power state comprises the operation of transmitting a null packet to the mobile station based on an active power state.
